(19) United States
(12) Patent Application Publication
(10) Pub. No.: US 2004/0028108 A1
(43) Pub. Date: Feb. 12, 2004

(54) Solid-state diode pumped laser employing oscillator-amplifier

(76) Inventors: Sergei V. Govorkov, Boca Raton, FL (US); Alexander Oliver Wolfgang Wiessner, Coconut Creek, FL (US)

Correspondence Address: STALLMAN & POLLOCK LLP, Suite 290, 121 Spear Street, San Francisco, CA, 94105, US

(21) Appl. No.: 10/360,309

(22) Filed: Feb. 6, 2003

Related U.S. Application Data
(60) Provisional application No. 60/355,078, filed on Feb. 7, 2002.

(51) Int. Cl. H01S 3/091; H01S 3/092; H01S 3/094

(52) U.S. Cl. 372/70; 372/75

(57) ABSTRACT

A solid-state laser system includes a solid state oscillator for generating a laser beam and a multiple stage amplifier for increasing an energy of the beam. The oscillator includes an elongated housing having an elongated cavity defined therein, a solid state rod disposed within the cavity, a pumping source for exciting laser active species within the rod, and a resonator including the rod disposed therein for generating a laser beam. The multiple-stage amplifier preferably includes an even number of stages. One or more pairs of compensating stages may be mutually rotated about the beam axis by substantially 90°, with each pumping direction parallel to the polarization direction of the beam. A first stage may be side-pumped by a pumping radiation source in a direction substantially parallel to a polarization direction of the beam generated by the oscillator resonator. A divergence adjusting optic may be disposed before at least one stage of the amplifier for adjusting a divergence of the beam prior to entering the amplifier stage. A divergence adjusting optic may be disposed after the amplifier stage having the divergence adjusting optic before it and before a second amplifier stage, and may be adjustable as to its divergence adjustment.

### PRIORITY

This application claims the benefit of priority to U.S. provisional patent application serial number No. 60/355,078, filed Feb. 7, 2002.

### BACKGROUND OF THE INVENTION

1. Field of the Invention

The invention relates to solid state lasers, and particularly to a high power two-stage solid-state oscillator-amplifier system

2. Description of the Related Art

Many emerging applications of solid-state lasers require high quality and high power laser beams. Examples of such applications are micromachining of micro-vias in microelectronics, fuel injector nozzles in automotive industry, extrusion dies, miniature medical devices, and various components for fiber-optics communication devices, among others known to those skilled in the art. For these applications and potentially many others, it is desired that the parameters of the beam, especially the spatial intensity distribution, be substantially constant throughout the useable lifetime of the laser (typically up to 20,000 hours). It is also desired to have a system with reduced deviations of the beam from circularity, and with reduced depolarization of the beam.

It is recognized in the present invention that a primary reason that the above-mentioned flaws in the beam profile arise from the pump intensity being varied across the rod. The laser gain profile may vary across the rod in a way that the gain distribution is not uniform and not radially-symmetric. The pump-induced thermal lens may be, therefore, also slightly non-spherical, and may have an additional cylindrical term in it. Also, induced birefringence also does not follow radial symmetry. It is desired to have an improved system.

### SUMMARY OF INVENTION

In view of the above, a solid-state laser system includes a solid state oscillator for generating a laser beam and a multiple stage amplifier for increasing an energy of the beam. The oscillator includes an elongated housing having an elongated cavity defined therein, a solid state rod disposed within the cavity, a pumping source for exciting laser active species within the rod, and a resonator including the rod disposed therein for generating a laser beam. The multiple-stage amplifier preferably includes an even number of stages. One or more pairs of compensating stages may be mutually rotated about the beam axis by substantially 90°. A first stage may be side-pumped by a pumping radiation source in a direction substantially parallel to a polarization direction of the beam generated by the oscillator resonator. A divergence adjusting optic may be disposed before at least one stage of the amplifier for adjusting a divergence of the beam prior to entering the amplifier stage. A divergence adjusting optic may be disposed after the amplifier stage having the divergence adjusting optic before it and before a second amplifier stage, and may be adjustable as to its divergence adjustment.

A half-wave plate may be disposed between at least one compensating pair of stages of the amplifier. A quarter-wave plate may also be disposed between the at least one compensating pair of stages of the amplifier. A quartz rotator may be disposed between at least one compensating pair of stages of the amplifier.

In one embodiment, the oscillator may include a side-pumped diode-pumped solid-state laser device. The elongated housing may further have an elongated opening defined between the cavity and the exterior of the housing. The solid-state rod may be surrounded by a cooling fluid. The device may further include a cover seal outside the housing and sealably covering the opening and thereby enclosing the cavity of the housing. The cover seal may be formed of a material that is at least substantially transparent to pumping radiation at a predetermined pumping wavelength. The pumping source may include a diode array proximate to the cover seal for emitting pumping radiation that traverses the cover seal and the opening to be absorbed by the rod to excite laser active species within the rod. Indeed, throughout much of the discussion herein the description of different aspects, and possible embodiments, of the oscillator is also applicable to the side-pumped solid-state laser device of the amplifier stages.

In one embodiment, each stage of the amplifier also includes a side-pumped solid-state laser device. The amplifier including an elongated housing and having an elongated opening defined between a cavity and the exterior of the housing. A solid-state rod may be surrounded by a cooling fluid. The device may further include a cover seal outside the housing and sealably covering the opening and thereby enclosing the cavity of the housing. The cover seal may be formed of a material that is at least substantially transparent to pumping radiation at a predetermined pumping wavelength. The pumping source may include a diode array proximate to the cover seal for emitting pumping radiation that traverses the cover seal and the opening to be absorbed by the rod to excite laser active species within the rod.

In another embodiment, the oscillator may include a side-pumped diode-pumped solid-state laser device. The elongated housing may further have an elongated opening defined between the cavity and the exterior of the housing. The elongated opening may have a radial extent defined from a center of the cavity of at least 30°. The solid-state rod may be surrounded by a cooling fluid. The device may further comprise a cover seal sealably covering the opening and thereby enclosing the cavity. The cover seal may be formed of a material that is at least substantially transparent to pumping radiation at a predetermined pumping wavelength. The pumping source may include a diode array proximate to the cover seal for emitting pumping radiation that traverses the cover seal and the opening to be absorbed by the rod to excite laser active species within the rod.

In a further embodiment, the oscillator may include a side-pumped diode-pumped solid-state laser device. The elongated housing may include a diffuse reflector housing having an elongated cavity defined therein by a diffusely reflective cavity wall. The housing may further have an elongated opening defined between the cavity and the exterior of the housing. The solid-state rod may be surrounded by a cooling fluid. The device may further include a cover seal sealably covering the opening and thereby enclosing the cavity. The cover seal being formed of a material that is at least substantially transparent to pumping radiation at a predetermined pumping wavelength. The pumping source comprising a diode array proximate to the cover seal for emitting the pumping radiation that traverses the cover seal and the opening to be absorbed by the rod to excite laser active species within the rod, wherein a substantial portion of the pumping radiation absorbed by the rod is first reflected from the diffuse reflector housing.

### BRIEF DESCRIPTION OF THE DRAWINGS

FIG. 1 schematically illustrates a two-stage amplifier component of a solid-state oscillator-amplifier system according to a preferred embodiment.

FIG. 2 schematically illustrates a cross-sectional view of an oscillator component of a solid-state oscillator-amplifier system according to a preferred embodiment. This is also a cross-sectional view of a pump chamber of an embodiment of a stage of the amplifier.

FIG. 3 is a graph in a cross-sectional plane illustrating a depolarization compensation feature in accordance with a preferred embodiment.

FIG. 4 illustrates an intensity distribution in the cross-sectional plane of a single array side-pumped, diode-pumped solid-state rod.

### INCORPORATION BY REFERENCE

Many details of the preferred solid-state laser, master oscillator, multiple-stage power amplifier, or MOPA, system are set forth in previous patent applications and other references. What follows is a cite list of references which are, in addition to the above and below description herein, hereby incorporated by reference as portions of the detailed description of the preferred embodiments, as disclosing alternative embodiments of elements or features of the preferred embodiments not otherwise set forth in detail above or below. A single one or a combination of two or more of these references may be consulted to obtain a variation of the preferred embodiments described herein:

U.S. Pat. Nos. 6,477,192, 6,463,086, 6,466,599, 6,426,966, 6,424,666, 6,421,365, 6,404,796, 6,404, 795, 6,399,916, 6,389,052, 6,381,256, 6,327,290, 6,272,158, 6,269,110, 6,226,307, 6,212,214, 6,157,662, 6,154,470, 6,559,816, 6,559, 815, 6,396,514, 6,247,534, 5,226,050, 5,161,238, 5,140,600, 4,977,573, 4,905,243, 4,534,034, 4,393,505, 6,005,880, 5,150,370, 5,596,596, 5,642,374, 5,852,627, 5,901,163, 6,381,257, 6,370,174, 6,442,181, and 6,359,922;

U.S. published application Nos. 2002/0114362, 2002/0105995, 2002/0075933, 2002/0075932, 2002/0057723, 2002/0041616, 2002/0041614, 2002/0031159, 2002/0021729, 2002/0018505, 2002/0006148, 2001/0009560, and 2001/0000606; and

U.S. patent application Ser. Nos. 10/211,971, 09/640,595, 09/858,147, 09/936,329, 09/843,604, 09/883,128, 60/359,181, 60/399,797, 60/382,893, 60/355,078, 60/424,186, 60/434,102, 60/434,695, 60/419,176, 09/717,757, 09/792,622, 09/926,329 and 60/346,781; all of the above patent applications being assigned to the same assignee as the present application;

U.S. published application Nos. 2002/0154671, 2002/0154668, 2002/0114370, 2002/0085606, 2002/0071468, 2002/0064202, and 2002/0044586; and

K. Vogler, “Advanced F2-laser for Microlithography”, Proceedings of the SPIE 25th Annual International Symposium on Microlithography, Santa Clara, February 28-Mar. 3, 2000, p.1515;

and with particular respect to the oscillator of the laser system:

Walter Koechner, “Solid State Laser Engineering”, pp. 127-140, 709 (Springer series in optical sciences, v.1, Springer-Verlag, Berlin, Heidelberg, N.Y., 1996);

Frank Hanson and Delmar Haddock, “Laser diode side pumping of neodymium laser rods”, Applied Optics, vol.27, no.1,1988, pp.80-83;

H. Ajer, et al., “Efficient diode-laser side-pumped TEM00-mode Nd:YAG laser”, Optics Letters, vol.17, no.24, 1992, pp.1785-1787;

Jeffrey J. Kasinski, et al., “One Joule Output From a Diode Array Pumped Nd:YAG Laser with Side Pumped Rod Geometry”, J. of Quantum Electronics, Vol. 28, No. 4 (April 1992);

D. Golla, et al., “300-W cw Diode Laser Side Pumped Nd:YAG Rod Laser”, Optics Letters, Vol. 20, No.10 (May 15, 1995)

Japanese patent no. JP 5-259540;

U.S. Pat. Nos. 5,774,488, 5,521,936, 5,033,058, 6,026,109, 5,870,421, 5,117,436, 5,572,541, 5,140,607, 4,945,544, 5,875,206, 5,590,147, 3,683,296, 3,684,980, 3,821,663, 5,084,886, 5,661,738, 5,867,324, 5,963,363, 5,978,407, 5,661,738, 4,794,615, 5,623,510, 5,623,510, 3,222,615, 3,140,451, 3,663,893, 4,756,002, 4,794,615, 4,872,177, 5,050,173, 5,349,600, 5,455,838, 5,488,626, 5,521,932, 5,590,147, 5,627,848, 5,627,850, 5,638,388, 5,651,020, 5,838,712, 5,875,206, 5,677,920, 5,905,745, 5,909,306, 5,930,030, 5,987,049, 5,995,523, 6,009,114, and 6,002,695;

German patent no. DE 689 15 421 T2;

Canadian patent no. 1,303,198;

French patent nos. 1,379,289 and 2,592,530;

Fujikawa, et al., “High-Power High-Efficient Diode-Side-Pumped Nd:YAG Laser”, Trends in Optics and Photonics, TOPS Volume X, Advanced Solid State Lasers, Pollock and Bosenberg, eds., (Topical Meeting, Orlando, Fla., Jan. 27-29, 1997);

R. V. Pole, IBM Technical Disclosure Bulletin, “Active Optical Imaging System”, Vol. 7, No. 12 (May 1965);

Devlin, et al., “Composite Rod Optical Masers”, Applied Optics, Vol.1, No. 1 (January 1962);

Goldberg et al., “V-groove side-pumped 1.5 μm fibre amplifier,” Electronics Letters, Vol. 33, No. 25, Dec. 4, 1997);

Welford, et al., “Efficient TEM₀₀-mode operation of a laser diode side-pumped Nd:YAG laser, Optics Letters, Vol.16, No. 23 (Dec. 1, 1991);

Welford, et al., “Observation of Enhanced Thermal Lensing Due to Near-Gaussian Pump Energy Deposition in a Laser Diode Side-Pumped Nd:YAG Laser,” IEEE Journal of Quantum Electronics, Vol. 28, No. 4 (Apr. 4, 1992);

Walker, et al., Efficient continuous-wave TEM₀₀ operation of a transversely diode-pumped Nd:YAG laser,” Optics Letters, Vol. 19, No. 14 (Jul. 15, 1994); and

Comaskey et al., “24-W average power at 0.537 μm from an externally frequency-doubled Q-switched diode-pumped ND:YOS laser oscillator,” Applied Optics, Vol. 33, No. 27 (Sep. 20, 1994).

### DETAILED DESCRIPTION OF PREFERRED EMBODIMENTS

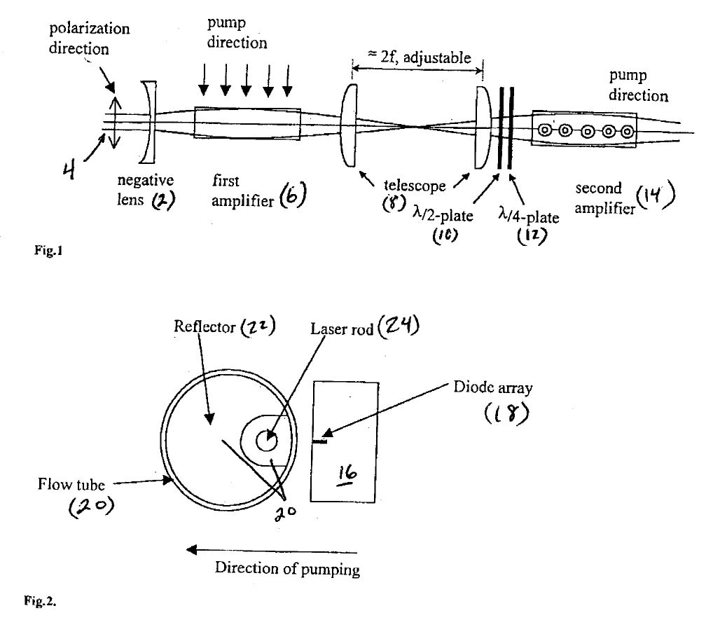

A two-stage solid-state oscillator-amplifier system according to a preferred embodiment is schematically illustrated at FIG. 1. The system of FIG. 1 includes a negative lens 2 in the beam path of a polarized beam 4 generated by the oscillator component of the oscillator-amplifier system. The preferred oscillator is illustrated in cross-section at FIG. 2 and described below and at U.S. patent application Ser. No. 09/938,329, SOLID-STATE DIODE PUMPED LASER EMPLOYING OSCILLATOR-AMPLIFIER, filed Aug. 21, 2002, which is assigned to the same assignee as the present application and is hereby incorporated by reference. The beam 4 is shown polarized vertically in the plane of the drawing sheet. A first amplifier stage 6 is disposed after the negative lens 2 along the beam path.

The first amplifier stage 6 and the second amplifier stage 14 can utilize the same structure as shown in FIG. 2. The first amplifier is preferably side-pumped and at FIG. 1 the side-pumping radiation is incident from the top of the drawing sheet in a direction within the plane of the drawing sheet and parallel to the polarization of the beam 4. A telescope 8 is disposed after the first amplifier stage 6. Next is a λ/2 plate 10 followed by a λ/4 plate 12. A second amplifier stage 14 is disposed after the plates 10, 12. The second amplifier is preferably side-pumped in a direction perpendicular to the plane of the drawing sheet, which is perpendicular to the direction of the pumping radiation for the first amplifier stage and to the polarization direction of the incident beam 4.

The system of FIG. 1 includes several advantageous features. First, the system features compensation of a pump-induced cylindrical thermal lens in the laser rod by proper selection of the beam polarization. Second, the system features adjustable mode-size matching inside the laser rods. Third, the system features birefringence compensation in the laser rods.

To obtain high output power with high beam quality from a solid state laser (such as Nd:YAG laser), an oscillator-amplifier setup is preferably employed in accordance with a preferred embodiment. The master oscillator emits a TEM₀₀ beam 4 with superior beam quality and high degree of polarization, but with comparably low output power. This output is then amplified in one or more amplifier stages, e.g., stages 6 and 14 of FIG. 1. To maintain high beam quality, the beam is preferably not distorted in the amplifier stages 6, 14. The amplifiers 6, 14 are more sensitive to distortions in the laser gain variations across the rod, because the beam passes only a single time through the laser rod, compared with multiple passes in the oscillator. Therefore, in the oscillator, the beam undergoes multiple steps of spatial filtering before it is output and thus acquires high spatial quality.

In the amplifier of the preferred embodiment, special care is preferably taken to minimize distortions due to primarily three reasons. First, wavefront distortions are caused by a thermal lens effect in the rod. Second, variations of the laser gain occur across the rod. Third, depolarization of the beam occurs due to induced birefringence of the rod.

FIG. 2 schematically illustrates a cross-sectional view of the preferred oscillator, and of a pump chamber of a stage of the amplifier. The operation of this device is described in greater detail at the Ser. No. 09/938,329 application, incorporated by reference above. The preferred embodiment preferably uses pump chambers (“heads”) 16 incorporating a single diode array 18 (consisting typically of 3 bars) closely spaced to the flow cell 20, which in turn comprises a diffuse reflector 22 and the laser rod 24. The preferred design has several advantages such as compactness, simplicity, and efficiency.

The preferred embodiment further uses an amplifier setup that includes two stages 6 and 14 (see FIG. 1) rotated at 90° with respect to each other. Advantageously, most of the distortions of the first stage 6 will be compensated by the second stage 14. Second, selection of the proper plane of the beam polarization inside the amplifiers prevents distortions in each stage 6,14. Third, additional quarter-wave plate 12, or quartz polarization rotator (not shown), between the stages 6,14 further helps reduce the depolarization of the beam. Fourth, the preferred embodiment provides means to optimize the mode size and divergency of the beam in the rod. Below, these advantageous features are described in more detail.

The preferred embodiments provide improved quality of the output beam by reducing the negative effects described in the background above. In applications such as micro-machining, this permits the creation of higher quality and smaller size micro-features, and also the processing of tougher materials at higher throughput, because the higher-quality beam can be focused into a spot of smaller size and higher intensity.

A preferred 2-stage amplifier setup, as shown in FIG. 1, includes two pump heads 6,14, a telescope 8 between the stages 6,14, a λ/2-plate 10 between the stages 6,14, and a negative lens 2 in front of the first stage 6 and a λ/4-plate 12 in front of the second stage 14. It should be noted that the number of stages is not limited to two, and in theory could range from one stage to an unlimited number. It is preferred, however, to have an even number, for the reasons of distortion compensation.

### EFFECT OF THE PUMP GEOMETRY AND POLARIZATION ON THE BEAM QUALITY

The design of the pump head is preferably substantially as described in the '329 application, mentioned above. The pump head preferably includes a laser rod 24 centered in an U-shaped diffuse ceramic reflector 22, inside a flow tube 20 (see FIG. 2). The laser rod 24 is pumped from one side by a single-row or double-row laser diode array 18, or any number of closely space rows (sometimes referred to in the art as “stacking” bars). Part of the pump light is directly absorbed by the laser rod 24. The transmitted light, as well as the light that does not directly hit the rod 24, is diffusely scattered by the ceramic reflector 22 and passes through the laser rod 24 again.

Compared to a pump head design that uses several diode arrays placed around the laser rod (e.g., in a “star” configuration), this pump head design has the advantage of a relative insensitivity of the pump intensity distribution in the rod 24 to aging of the diodes 18. While for a star configuration, the pump intensity distribution changes if the diodes age unevenly, for the single side pumping, only the intensity, not the distribution, will change. The shape of the pump intensity distribution is given by the pump geometry. As the diodes 18 age, resulting changes in the thermal lens can be compensated for by adjusting the electric current flowing through the diodes. This method will not work properly for a star configuration, as the diodes may respond differently to such increases, and shape of the pump intensity distribution depends on the relative intensities of the diode arrays, in addition to the pump geometry.

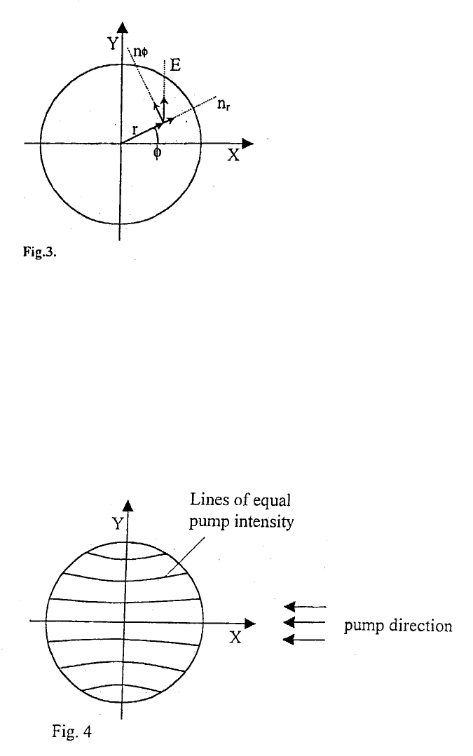

A disadvantage of a single-side pump geometry can be a non radially-symmetrical pump intensity distribution profile. Considering the intensity distribution in the cross-sectional plane of the rod (see FIG. 4), it is a superposition of a homogenous part, a part symmetrical with-respect to the pump (X) axis (see FIG. 3), and a part with the slope along the pump axis. The third part is quite weak and can be ignored in the following analysis. The resulting thermal lens is not spherical, but is a superposition of spherical and cylindrical components. The plane containing the laser rod and the diode array (pump axis or pump direction, X), also contains the axis of the resulting cylindrical lens and the gradient vector of the third, sloped component.

An equation defining the thermal lens with focal length f resulting from thermo-optical and elasto-optical effects in a uniformly pumped laser rod can be found in the literature (see, e.g., W. Koechner, Solid-State Laser Engineering, Fifth edition, Springer 1999, Chapter 7.1.1):

$$f = \frac{K}{QL} {( \frac{1}{2} \frac{ⅆ n}{ⅆ T} + α {C}_{r , φ} {n}_{0}^{3} + \frac{α {r}_{0} ( {n}_{0} - 1 )}{L} )}^{- 1} \qquad ( 1 )$$

where Q is the pump power per volume unit absorbed by the laser rod, L is the illuminated length of the rod, r₀ is the radius of the laser rod, n₀ is the refractive index, dn/dT is the temperature dependence of the refractive index, K is the thermal conductivity, α is the thermal expansion coefficient, Cᵣ and C₁₀₀ are the elasto-optical coefficients for the radial and tangential polarization correspondingly.

The thermal lens is mainly generated by 1) The temperature dependence of the refractive index n(T) (first term of equation (1)); 2) Stress-induced elasto-optical effects (second term), and 3) Distortions of the end surfaces of the laser rod (third term). The “dn/dT” term is responsible for a radially-symmetrical (spherical) lens. The stress-induced part of the thermal lens, which contributes about 20% to the focal length, is birefringent and can be separated into a radial and a tangential part. For example, if the light is polarized along the X-axis, light on the X-axis only sees the radial part, and light on the Y-axis only sees the tangential parts. Light passing at any other point through the rod will see a superposition of the two parts. Therefore, if the tangential and radial coefficients are not equal, and the light inside the laser rod is polarized, the effective lens becomes a superposition of a spherical and a cylindrical lens. For YAG, the radial part is much-stronger than the tangential part (by a factor of 7) and has the opposite sign. Thus, for example, a horizontally polarized beam will effectively “see” a cylindrical lens extended in the vertical direction—in addition to the regular spherical lens. Finally, end effects lead to a spherical lens and contribute only 6% to the focal length.

Because the actual intensity distribution is not uniform, it is difficult to apply rigorously this formula to the above described pump geometry, but a simple analysis can show a general trend of the effects involved. As the pump intensity distribution is a superposition of an almost homogeneous part and a mirror-plane symmetrical part, the cylindrical portion of the thermal lens resulting from the “dn/dT” term has its axis in the pump plane. A feature of the preferred embodiment is that this cylindrical portion of the thermal lens arising due to the pump intensity distribution is compensated, by the cylindrical lens caused by the stress-induced birefringence of the rod (which occurs even in an uniformly pumped rod, as described above). In other words, an increase of the optical index due to the second term in equation (1) will add to the index distribution caused by the first term, to result in an almost radially-symmetric index distribution. Since the axis of the distribution-induced lens is in the pump plane, and the axis of the stress-induced lens is perpendicular to the polarization plane, and the compensation occurs when these two lenses are crossed, it means that the beam has to be polarized parallel to the pump plane. For light polarized parallel to the axis of pumping, the cylindrical part of the thermal lens is therefore drastically reduced, resulting in an almost spherical thermal lens, while for light perpendicular to this axis, the cylindrical part is increased. Taking the coefficient values for Nd:YAG found in the literature (see Koecher, chapter 7.1.1), the calculations with formula (1) show that the polarization-dependent stress-induced part can compensate for a cylindrical lens with the optical power of about 24% of the spherical lens. This is a substantial amount, and experimentally we have observed practically complete compensation.

In addition to such compensation, the preferred embodiment uses a two-stage amplifier design. Also, it is possible to use four or more stages, as long as there is an even number of stages. As it cannot be ensured that the above described polarization dependence fully compensates for the cylindrical part of the thermal lens and other distortions, the two stages in each pair are rotated by 90° with respect to each other. This arrangement compensates for residual non-spherical parts. In between the stages, a λ/2-plate is placed, which rotates the polarization of the light by 90° before it passes through the second stage. Thus, the light passing the second stage of the pair is subjected to distortions that are similar to those in the first stage, but rotated at 90 degrees. Experimentally, this results in an almost perfectly circular amplified beam.

### MODE SIZE MATCHING

The fill factor of the laser rod is advantageously controlled in accordance with the preferred embodiment for obtaining a good beam profile. For example, it is recognized herein that if the rod is overfilled, the outer portion of the beam may be significantly blocked, and diffraction on the edges of the rod may occur, which is visible as a ring pattern in the beam profile. It is also recognized herein that if the rod is under-filled, the energy extraction may be significantly reduced and the unfilled portion of the rod may emit significant amounts of ASE (amplified spontaneous emission). It is therefore desirable to fill both amplifier laser rods optimally.

In addition to the fill factor, we found experimentally that the divergency of the beam in the rod is also important. There is an effect of the divergency on the quality of the output beam. The optimal divergency of the incident beam is such that the output beam converges, as shown in FIG. 1. It is possible because the rod acts as a positive lens. Therefore, the wavefront curvature radius of the input beam is preferably adjusted to about twice the focal length of this lens to make the output beam converge, with approximately a same degree as is the input divergence. The exact value of the focusing power of the amplifier stages and the divergence of the beam originating from the oscillator are not known precisely in general, because these parameters vary from laser to laser. To fill both amplifier stages perfectly, it is preferred to adjust 1) divergency and diameter of the beam at the entrance of the first amplifier stage, and 2) same beam parameters in between the amplifier stages. The negative lens 2 (see FIG. 1) in front of the first stage allows an increase of the divergency of the beam. In order to adjust the beam diameter, one can adjust the distance between the lens 2 and the first stage 6. An additional benefit of this optimal mode size matching is that these rods also act as apertures, thus defining the circularity of the beam.

An adjustable telescope 8 between the stages 6,14 is used to advantageously change/adjust the divergence of the beam and thereby the fill factor of the second amplifier rod. Here, the distance to the second stage 14 can be adjusted in order to optimize beam diameter, in addition to the divergency. The telescope 8 preferably comprises two best-form positive lenses. The focal length of the lenses, the spacing of the lenses, and the distance to the amplifiers are chosen as described below. In W. Koechner, Solid State Laser Engineering, Fifth Edition, Spinger, 1999, Chapter 7.1.1 and pages 425 ff (the entire book being hereby incorporated by reference), a setup is described which images the principle planes of the thermal lenses of the rods. However, in the preferred embodiment, the telescope 8 acts to convert the beam from convergent into divergent, so effectively the telescope 8 acts as a negative lens. The divergence after the first amplifier stage is not known precisely, and it may vary from setup to setup due to variation of pump parameters and other factors. Therefore, the spacing of the lenses in the telescope 8 is made adjustable to adjust the divergence at the input of the second amplifier stage 14. In combination with the adjustable spacing between the telescope 8 and the second stage 14, this ensures that the mode size in the laser rod in the second stage 14 is matched as well.

### COMPENSATION OF DEPOLARIZATION

As is discussed above, the pump light can induce stress in the laser rod, which, can in turn, lead to induced birefringence. This means that the linearly polarized light may undergo some depolarization, whose magnitude depends on the position in the rod. The locations on the axes X and Y (see FIG. 3) do not introduce any depolarization, while the areas around 45°, 135°, 225°, 315° produce an elliptically polarized beam at the output, instead of a linearly polarized one. The total depolarization of the entire amplifier can be reduced by placing an additional λ/4-plate 12 in between the stages 6,14, with its optical axis oriented at 0° to either the X or Y axis. Linearly polarized light will not be affected by this plate, but depolarized light from the areas at 45 degrees will receive a quarter-wave phase shift between the fast and slow components. This effectively makes the fast component from the first stage 6 to become a slow component in the second stage 14, and vice versa. Therefore, a phase shift that occurred in the first stage 6 is compensated for in the second stage 14. Alternatively, a quartz rotator (not shown) can be used in place of both the λ/4 plate 12 and λ/2 plate 10. An advantage here is that there are fewer optical components. However, use of a quartz rotator may increase the cost of the system.

The depolarization effects described in this section are not specific to the pump cell used in the preferred embodiment. Even a cell with a perfectly uniform pump intensity distribution exhibits similar depolarization effects (see Koechner, chapter 7.1.1, mentioned above). Non-uniformity of the pump intensity in the system of the preferred embodiment may cause an additional, second-order, depolarization term. This term is compensated for due to the fact that the stages 6,14 are rotated by 90 degrees with respect to each other.

### ALTERNATIVE EMBODIMENTS

Many alternative embodiments are possible. For example, the telescope 8 may include a pair of negative lenses, rather than the preferred positive lenses. Other kinds of pump heads may be used. Multiples of the two stages of the amplifier may be used, e.g., 4, 6, 8, . . . The additional laser rods will preferably have telescopes and waveplates or quartz rotators in between the stages.

While exemplary drawings and specific embodiments of the present invention have been described and illustrated, it is to be understood that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

What is claimed is:

1. A solid state laser system, comprising:
(a) a solid state oscillator, including:
an elongated housing having an elongated cavity defined therein,
a solid state rod disposed within the cavity,
a pumping source for exciting laser active species within the rod, and
a resonator including the rod disposed therein for generating a laser beam; and
(b) a multiple-stage amplifier for increasing and energy of the beam including an even number of stages, one or more pairs of compensating stages being mutually rotated about the beam axis by substantially 90°.

2. A solid state laser system, comprising:
(a) a solid state oscillator, including:
an elongated housing having an elongated cavity defined therein,
a solid state rod disposed within the cavity,
a pumping source for exciting laser active species within the rod, and
a resonator including the rod disposed therein for generating a laser beam; and
(b) a multiple stage amplifier for increasing an energy of the beam including at least a first stage side-pumped by a pumping radiation source in a direction substantially parallel to a polarization direction of the beam generated by the oscillator resonator.

3. The laser system of claim 2, a pair of compensating stages of said amplifier being mutually rotated about the beam axis by substantially 90°.

4. A solid state laser system, comprising:
(a) a solid state oscillator, including:
an elongated housing having an elongated cavity defined therein,
a solid state rod disposed within the cavity,
a pumping source for exciting laser active species within the rod, and
a resonator including the rod disposed therein for generating a laser beam;
(b) an multiple stage amplifier for increasing an energy of the beam; and
(c) a divergence adjusting optic before at least one stage of the amplifier for adjusting a divergence of the beam prior to entering the amplifier stage.

5. The laser system of claim 4, further comprising a second divergence adjusting optic after said amplifier stage having said divergence adjusting optic before it, said second divergence adjusting optic being disposed before a second amplifier stage and being adjustable as to an amount of its divergence adjustment.

6. The laser system of claim 5, the second divergence adjusting optic comprising a pair of lenses with adjustable spacing.

7. The laser system of claim 5, the second divergence adjusting optic comprising a pair of negative lenses with adjustable spacing.

8. The laser system of claim 4, a pair of compensating amplifier stages being rotated about the beam axis by substantially 90°.

9. The laser system of claim 4, at least a first stage being side-pumped by a pumping radiation source in a direction substantially parallel to a polarization direction of the beam generated by the oscillator resonator.

10. A solid state laser system, comprising:
(a) a solid state-oscillator, including:
an elongated housing having an elongated cavity defined therein,
a solid state rod disposed within the cavity,
a pumping source for exciting laser active species within the rod, and
a resonator including the rod disposed therein for generating a laser beam;
(b) an multiple stage amplifier for increasing an energy of the beam; and
(c) a divergence adjusting optic after a first amplifier stage and before a second amplifier stage, the divergence adjusting optic being adjustable as to an amount of its divergence adjustment.

11. The laser system of claim 10, the divergence adjusting optic comprising a pair of lenses with adjustable spacing.

12. The laser system of claim 10, the divergence adjusting optic comprising a pair of negative lenses with adjustable spacing

13. The laser system of claim 10, a pair of compensating amplifier stages being rotated about the beam axis by substantially 90°.

14. The laser system of claim 10, at least a first amplifier stage being side-pumped by a pumping radiation source in a direction substantially parallel to a polarization direction of the beam generated by the oscillator resonator.

15. The laser system of any of claims 1, 2, 4 or 10, further comprising a half-wave plate between at least one compensating pair of stages of the amplifier.

16. The laser system of claim 15, further comprising a quarter-wave plate between said at least one compensating pair of stages of the amplifier.

17. The laser system of any of claims 1, 2, 4 or 10, further comprising a quartz rotator between at least one compensating pair of stages of the amplifier.

18. The laser system of any of claims 1, 2, 4 or 10, the oscillator including a side-pumped diode-pumped solid state laser device, said elongated housing further having an elongated opening defined between the cavity and the exterior of the housing, said solid state rod being surrounded by a cooling fluid, the device further comprising a cover seal outside the housing and sealably covering the opening and thereby enclosing the cavity of the housing, the cover seal being formed of a material that is at least substantially transparent to pumping radiation at a predetermined pumping wavelength, said pumping source comprising a diode array proximate to the cover seal for emitting pumping radiation that traverses the cover seal and the opening to be absorbed by the rod to excite laser active species within the rod.

19. The laser system of any of claims 1, 2, 4 or 10, the oscillator including a side-pumped diode-pumped solid state laser-device, said elongated housing further having an elongated opening defined between the cavity and the exterior of the housing, the elongated opening having a radial extent defined from a center of the cavity of at least 30°, said solid state rod being surrounded by a cooling fluid, the device further comprising a cover seal sealably covering the opening and thereby enclosing the cavity, the cover seal being formed of a material that is at least substantially transparent to pumping radiation at a predetermined pumping wavelength, the pumping source comprising a diode array proximate to the cover seal for emitting pumping radiation that traverses the cover seal and the opening to be absorbed by the rod to excite laser active species within the rod.

20. The laser system of any of claims 1, 2, 4 or 10, the oscillator including a side-pumped diode-pumped solid state laser device, said elongated housing comprising a diffuse reflector housing having an elongated cavity defined therein by a diffusely reflective cavity wall, said housing further having an elongated opening defined between the cavity and the exterior of the housing, said solid state rod being surrounded by a cooling fluid, the device further comprising a cover seal sealably covering the opening and thereby enclosing the cavity, the cover seal being formed of a material that is at least substantially transparent to pumping radiation at a predetermined pumping wavelength, the pumping source comprising a diode array proximate to the cover seal for emitting the pumping radiation that traverses the cover seal and the opening to be absorbed by the rod to excite laser active species within the rod, wherein a substantial portion of the pumping radiation absorbed by the rod is first reflected from the diffuse reflector housing.

21. The laser system of any of claims 1, 2, 4 or 10, each stage of the multiple stage amplifier including a side-pumped diode-pumped solid state laser device, wherein each side-pumped solid state laser device includes:
an elongated housing having an elongated cavity defined therein, said elongated housing further having an elongated opening defined between the cavity and the exterior of the housing;
a solid state rod disposed within the cavity, said solid state rod being surrounded by a cooling fluid; and
the device further comprising a cover seal outside the housing and sealably covering the opening and thereby enclosing the cavity of the housing, the cover seal being formed of a material that is at least substantially transparent to pumping radiation at a predetermined pumping wavelength, said pumping source comprising a diode array proximate to the cover seal for emitting pumping radiation that traverses the cover seal and the opening to be absorbed by the rod to excite laser active species within the rod.

22. The laser system of any of claims 1, 2, 4 or 10, each stage of the multiple stage amplifier including a side-pumped diode-pumped solid state laser device, wherein each side-pumped solid state laser device includes:
an elongated housing having an elongated cavity defined therein, said elongated housing further having an elongated opening defined between the cavity and the exterior of the housing, the elongated opening having a radial extent defined from a center of the cavity of at least 30°;
a solid state rod disposed within the cavity, said solid state rod being surrounded by a cooling fluid; and
the device further comprising a cover seal sealably covering the opening and thereby enclosing the cavity, the cover seal being formed of a material that is at least substantially transparent to pumping radiation at a predetermined pumping wavelength, the pumping source comprising a diode array proximate to the cover seal for emitting pumping radiation that traverses the cover seal and the opening to be absorbed by the rod to excite laser active species within the rod.

23. The laser system of any of claims 1, 2, 4 or 10, each stage of the multiple stage amplifier including a side-pumped diode-pumped solid state laser device, wherein each side-pumped solid state laser device includes:
an elongated housing having an elongated cavity defined therein, said elongated housing comprising a diffuse reflector housing having an elongated cavity defined therein by a diffusely reflective cavity wall, said housing further having an elongated opening defined between the cavity and the exterior of the housing;
a solid state rod disposed within the cavity, said solid state rod being surrounded by a cooling fluid;
the device further comprising a cover seal sealably covering the opening and thereby enclosing the cavity, the cover seal being formed of a material that is at least substantially transparent to pumping radiation at a predetermined pumping wavelength; and
a pumping source for exciting laser active species within the rod, the pumping source comprising a diode array proximate to the cover seal for emitting the pumping radiation that traverses the cover seal and the opening to be absorbed by the rod to excite laser active species within the rod, wherein a substantial portion of the pumping radiation absorbed by the rod is first reflected from the diffuse reflector housing.

24. The laser system of any of claims 1, 2, 4 or 10, each stage of the multiple stage amplifier including a side-pumped diode-pumped solid state laser device, wherein each side-pumped solid state laser device includes:
an elongated housing having an elongated cavity defined therein;
a solid state rod disposed within the cavity; and
a pumping source for exciting laser active species within the rod.
